(19) United States
(12) Patent Application Publication
(10) Pub. No.: US 2025/0033353 A1
(43) Pub. Date: Jan. 30, 2025

(54) LIQUID EJECTION HEAD AND METHOD OF MANUFACTURING LIQUID EJECTION HEAD

(71) Applicant: CANON KABUSHIKI KAISHA, Tokyo (JP)

(72) Inventor: KENJI TAMAMORI, Kanagawa (JP)

(21) Appl. No.: 18/782,715

(22) Filed: Jul. 24, 2024

(30) Foreign Application Priority Data
Jul. 26, 2023 (JP) 2023-121554

(51) Int. Cl. B41J 2/14; B41J 2/045; B41J 2/16

(52) U.S. Cl. CPC B41J 2/14201; B41J 2/04581; B41J 2/1607; B41J 2/1623; B41J 2202/22

(57) ABSTRACT

A liquid ejection head includes an ejection port configured to eject liquid, a pressure generating element configured to generate pressure to eject liquid from the ejection port, a pressure chamber on which pressure of the pressure generating element acts, a damper film configured to suppress liquid vibrations in the pressure chamber, and a first substrate including a recess portion to make the damper film flexible. The damper film is bonded to the first substrate with an adhesive to cover the recess portion. The adhesive protrudes from a bonding surface between the damper film and the first substrate to an inside of the recess portion. A portion of the adhesive protruding on a long side of the damper film has a width smaller than that of a portion of the adhesive protruding to a short side of the damper film.

### BACKGROUND

### Field of the Disclosure

The present disclosure relates to a liquid ejection head and a method of manufacturing the liquid ejection head.

### Description of the Related Art

As a liquid ejection apparatus, for example, an ink-jet recording apparatus is an apparatus that ejects liquid (ink) from an ejection port of a liquid ejection head, which ejects the liquid, to perform print on a medium. For example, a piezoelectric liquid ejection apparatus displaces a vibration plate with a piezoelectric element, which is installed at a position facing a pressure chamber that communicates with an ejection port, and fluctuates a volume of the pressure chamber to eject liquid from the ejection port. There is a possibility that so-called crosstalk, which is transmission of vibrations of the vibration plate to the ejection port through liquid in a liquid flow path, causes a failure of ejection of liquid from an adjacent ejection port. To reduce the influence of the crosstalk, there is a method using a damper and a method of performing delay control to delay an ejection timing. For example, Japanese Patent Application Laid-Open No. 2006-095725 proposes a liquid ejection head having a damper structure.

Japanese Patent Application Laid-Open No. 2006-095725 discusses, as the damper structure, a structure in which a flexible film is bonded onto an opening with an adhesive. Assuming a case where the adhesive protrudes into the opening, an end portion of a protrusion of the adhesive serves as a fixed end of the flexible film and a flexible region of the flexible film is thereby determined. When a damper region is reduced with densification of arrangement of ejection ports of a liquid ejection head, there is an issue that the flexible region of the flexible film becomes narrower by a protruding portion of the adhesive. Especially, because a ratio of a width of a protrusion of the adhesive to a width of a recess portion of a damper on a shorthand side is higher than a ratio of a width of a protrusion of the adhesive to a width of the recess portion on a longitudinal side, the shorthand side of the recess portion of the damper is more influenced by the protrusion of the adhesive.

Meanwhile, because the flexible film as the damper vibrates upward and downward, a closely-contact area between a substrate and the flexible film via the adhesive is reduced without the protruding portion of the adhesive. For this reason, without a structure of holding the flexible film side on an opposite surface of a surface with an opening in a damper structure, there are concerns especially about adhesion between the substrate and the flexible film.

### SUMMARY

The present disclosure is directed to provision of a liquid ejection head that ensures a flexible region necessary for a flexible film to function as a damper while also providing adhesion between a substrate and the flexible film, and a method of manufacturing the liquid ejection head.

According to an aspect of the present disclosure, a liquid ejection head includes an ejection port configured to eject liquid, a pressure generating element configured to generate pressure to eject liquid from the ejection port, a pressure chamber on which pressure of the pressure generating element acts, a damper film configured to suppress vibrations of liquid in the pressure chamber, and a damper substrate including a recess portion to make the damper film flexible, wherein the damper film is bonded to the damper substrate with an adhesive so as to cover the recess portion, wherein the adhesive protrudes from a bonding surface between the damper film and the damper substrate to an inside of the recess portion, and wherein, a portion of the adhesive protruding on a long side of the damper film has a width smaller than a width of a portion of the adhesive protruding to a short side of the damper film.

Further features of the present disclosure will become apparent from the following description of exemplary embodiments with reference to the attached drawings.

### BRIEF DESCRIPTION OF THE DRAWINGS

FIG. 1 is a perspective view illustrating a liquid ejection head according to a first exemplary embodiment.

FIGS. 2A and 2B are cross-sectional views each illustrating the liquid ejection head according to the first exemplary embodiment.

FIG. 3 is a plan view illustrating a flexible film of the liquid ejection head according to the first exemplary embodiment when viewed from an ejection port side.

FIG. 4 is a plan view illustrating the flexible film of the liquid ejection head according to the first exemplary embodiment when viewed from the ejection port side.

FIGS. 5A and 5B are cross-sectional views each illustrating an adhesive protruding to an inner end portion of a first recess portion of the liquid ejection head according to the first exemplary embodiment.

FIGS. 6A to 6C are plan views and cross-sectional views illustrating processes of manufacturing a liquid ejection head substrate according to a second exemplary embodiment.

FIG. 7 is a view illustrating an adhesive transfer process in the method of manufacturing the liquid ejection head substrate according to the second exemplary embodiment.

### DESCRIPTION OF THE EMBODIMENTS

Exemplary embodiments of the present disclosure will be described in detail below.

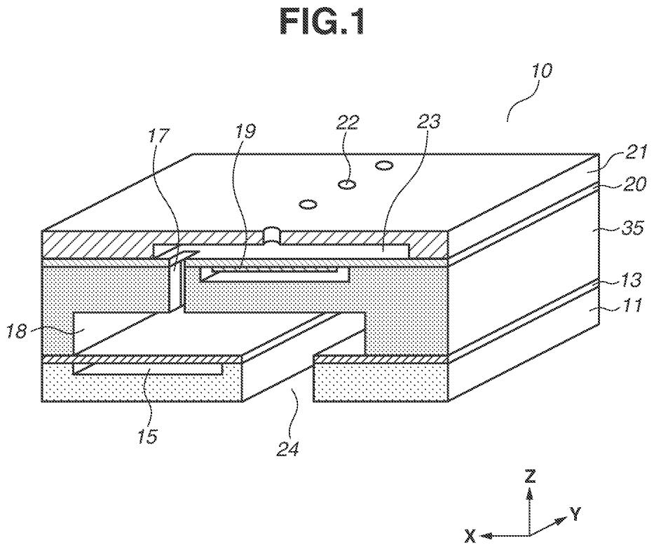

A liquid ejection head according to a first exemplary embodiment is now described with reference to a perspective view in FIG. 1. A liquid ejection head 10 includes a plurality of pressure chambers 23 each communicating with a corresponding one of a plurality of ejection ports 22, and a plurality of individual flow paths 17 each communicating with a corresponding one of the plurality of pressure chambers 23. Each pressure chamber 23 is a space on which pressure of a pressure generating element acts. The pressure generating element generates pressure for ejection of liquid. The individual flow paths 17 are formed in a pressure generating substrate 35. A surface facing the plurality of individual flow paths 17 includes, across a common flow path 18 that communicates with the plurality of individual flow paths 17, a flexible film (also referred to as a damper film) 13 that is bonded with an adhesive (not illustrated) so as to cover a first recess portion 15 that extends along an array direction of the individual flow paths 17. The damper film 13 is used to suppress vibrations of liquid in the pressure chambers 23. The first recess portion 15 is disposed so as to face the common flow path 18. That is, the damper film 13 suppresses vibrations of liquid in the common flow path 18 and thereby suppresses vibrations of liquid in the pressure chambers 23. Liquid ejected from the liquid ejection head 10 passes from a liquid supply flow path 24 across the common flow path 18 and is supplied to the pressure chambers 23 via the respective individual flow paths 17. The liquid ejection head 10 displaces a vibration plate 20 with a piezoelectric element 19, which is installed at a position facing the pressure chambers 23 via the vibration plate 20, and fluctuates volumes of the pressure chambers 23 to eject liquid from the ejection ports 22. An ejection port array composed of the plurality of ejection ports 22 arrayed in a Y-direction is formed in an ejection port substrate 21. The flexible film 13 functions as a damper for suppressing transmission of vibrations of the vibration plate 20 to an adjacent pressure chamber 23 through liquid in the common flow path 18 at the time of ejection of liquid. The first recess portion 15 is formed along the array direction of the ejection ports 22 as illustrated in FIG. 1. The first recess portion 15 is formed over the whole region of the common flow path 18. In the description of the present exemplary embodiment, the piezoelectric element 19 is used as an example of a pressure generating element that generates pressure for ejection of liquid from the ejection ports 22, but a heating element (heater) that heats liquid may be used.

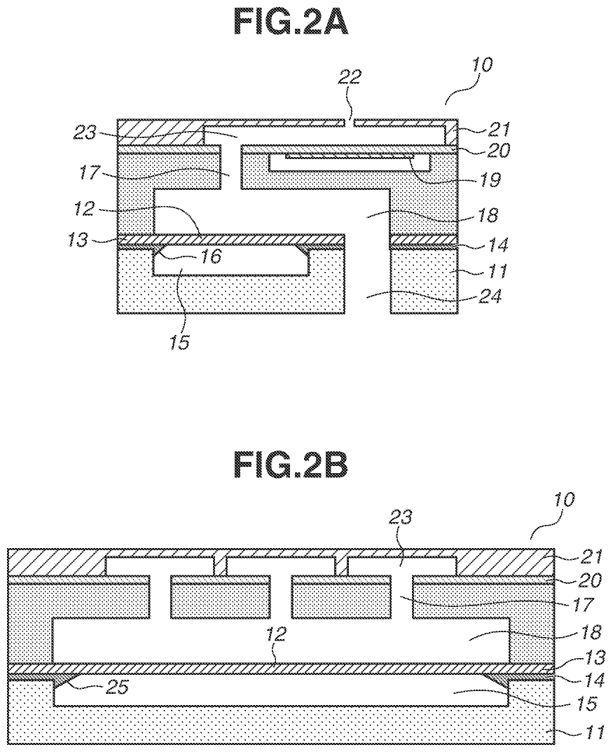

FIGS. 2A and 2B are cross-sectional views each schematically illustrating the liquid ejection head 10 in FIG. 1. FIG. 2A illustrates an X-Z cross section in a direction that is approximately perpendicular to an array direction of the ejection ports 22 (ejection port array direction) and an array direction of the individual flow paths 17. FIG. 2B illustrates a Y-Z cross section in a direction that is approximately parallel with the array direction of the individual flow paths 17.

FIG. 2A illustrates the cross section in a shorthand direction of the first recess portion as a recess portion for making the damper flexible. At an inner end portion of the first recess portion 15 to which the flexible film 13 is bonded via an adhesive 14 so as to cover the first recess portion 15, there is a protruding portion 16 of the adhesive 14. The protruding portion 16 is an adhesive protruding from a bonding surface between a damper substrate and the damper film 13 to the inside of the first recess portion 15. The protruding portion 16 is in contact with the flexible film 13 and an inner wall of the first recess portion 15. FIG. 2B illustrates the cross section in a longitudinal direction of the first recess portion 15. At the inner end portion of the first recess portion 15 to which the flexible film 13 is bonded via the adhesive 14 so as to cover the first recess portion 15, there is a protruding portion 25 of the adhesive 14. The protruding portion 25 is in contact with the flexible film 13 and the inner wall of the first recess portion 15. When comparison is made between widths of the protruding portions 16 and 25 that are in contact with the flexible film 13, the protruding portion 25 is formed to have a larger width.

In the shorthand direction of the first recess portion 15 in FIG. 2A, a necessary flexible region 12 is ensured by reduction of the width of the protruding portion 16, while the adhesion between a substrate 11 and the flexible film 13 can also be ensured due to a large width of the protruding portion 16 in the extending direction of the first recess portion 15. In other words, the width of the adhesive 14 protruding to the long side of the flexible film 13 is reduced. In the longitudinal direction of the first recess portion 15 illustrated in FIG. 2B, on the other hand, because the width of the flexible region 12 is large, it is possible to ensure also the adhesion between the substrate 11 and the flexible film 13 by increasing the width of the protruding portion 25, as compared with the shorthand direction. In other words, the width of the adhesive 14 protruding to the short side of the flexible film 13 is increased. That is, in the present exemplary embodiment, the width of the adhesive 14 protruding to the long side of the flexible film 13 is made smaller than the width of the adhesive 14 protruding to the short side of the flexible film 13.

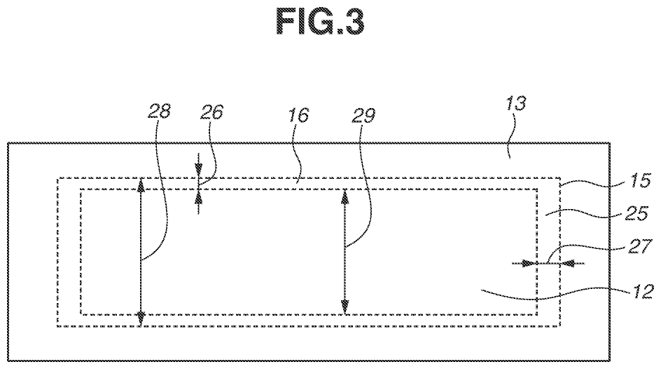

FIG. 3 is a plan view illustrating the flexible film 13 of the liquid ejection head 10 when viewed from the ejection port 22 side.

The flexible film 13 is bonded via the adhesive 14 (not illustrated) so as to straddle the first recess portion 15, and there are the protruding portions 16 and 25 of the adhesive 14 in the shorthand direction of the first recess portion 15 and the longitudinal direction of the first recess portion 15, respectively, inside the first recess portion 15. The protruding portions 16 and 25 of the adhesive 14 serve as fixed ends of the flexible film 13, whereby the flexible region 12 is determined.

A width 26 of the protruding portion 16 of the adhesive 14 in the shorthand direction on the inside of the first recess portion 15 is smaller than a width 27 of the protruding portion 25 in the longitudinal direction. When a recess portion width 28 in the shorthand direction of the first recess portion 15 (a width of the short side of the first recess portion 15) is Mₛ and the width of the protruding portion 16 in the shorthand direction (the width of the adhesive 14 protruding to the long side of the flexible film 13) is Hₛ, it is preferable that 2Hₛ/Mₛ be 0.2 or less. This is because the sufficient flexible region 12 of the flexible film 13 can be ensured. It is more preferable that 2Hₛ/Mₛ be 0.1 or less. For example, also in a case where a width of the protruding portion 16 in the shorthand direction of the first recess portion 15 is different between two ends of the first recess portion 15, with an average value of widths of protrusions at the two ends being Hₛ, it is preferable that 2Hₛ/Mₛ be 0.2 or less and more preferable that 2Hₛ/Mₛ be 0.1 or less. In the shorthand direction of the first recess portion 15, when a width 29 of the flexible region 12 of the flexible film 13 is Dₛ (=Mₛ−2Hₛ) and the width of the protruding portion 16 in the shorthand direction of the first recess portion 15 is Hₛ, it is preferable that Dₛ/Mₛ be 0.8 or more. This is because Dₛ/Mₛ being 0.8 or more can ensure the sufficient flexible region 12 of the flexible film 13. It is more preferable that Dₛ/Mₛ be 0.9 or more. For example, also in the case where the width of the protruding portion 16 in the shorthand direction of the first recess portion 15 is different between the two ends of the first recess portion 15, with an average value of widths of protrusions at the two ends being Hₛ, it is preferable that Dₛ/Mₛ be 0.8 or more and more preferable that Dₛ/Mₛ be 0.9 or more.

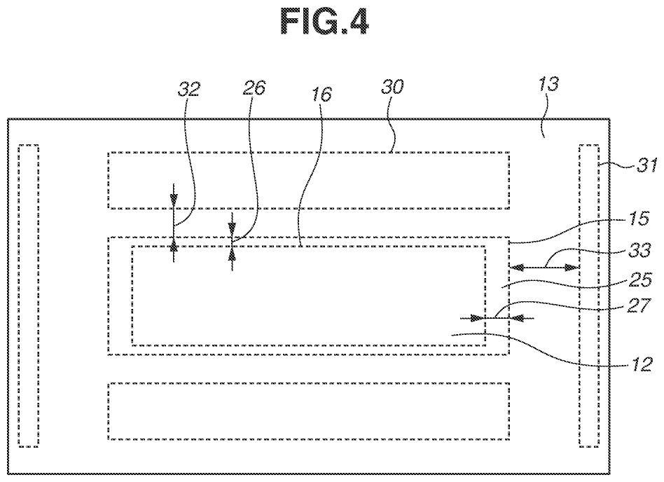

FIG. 4 is a plan view illustrating the flexible film 13 of the liquid ejection head 10 when viewed from the ejection port 22 side, and illustrates a wider region than the plan view illustrated in FIG. 3. The substrate 11 includes a second recess portion 30 adjacent to the first recess portion 15 in approximately parallel with the longitudinal direction of the first recess portion 15, and a third recess portion 31 adjacent to the first recess portion 15 in approximately perpendicular to the longitudinal direction of the first recess portion 15. When comparison is made between an interval 32 between the first recess portion 15 and the second recess portion 30 and an interval 33 between the first recess portion 15 and the third recess portion 31, the interval 33 is formed to be larger. When the flexible film 13 is bonded to the first recess portion 15 via the adhesive 14 (not illustrated), the adhesive 14 is squashed and the protruding portions 16 and 25 are formed inside the first recess portion 15. An amount of the adhesive 14 on the interval 33, which is larger than the interval 32, between the first recess portion 15 and the third recess portion 31 before squashing of the adhesive 14 is larger than an amount of the adhesive 14 on the interval 32 between the first recess portion 15 and the second recess portion 30. For this reason, regarding a width of a protruding portion formed by squashing of the adhesive 14, the width 27 of the protruding portion 25 in the longitudinal direction of the first recess portion 15 is larger than the width 26 of the protruding portion 16 in the shorthand direction of the first recess portion 15. Hence, at the end in the shorthand direction of the first recess portion 15 of the damper, the necessary flexible region 12 can be ensured by reduction of the width of the protrusion of the adhesive 14, while the adhesion between the substrate 11 and the flexible film 13 can also be ensured due to the large width of the protruding portion 16 of the adhesive 14 in the extending direction of the first recess portion 15. In contrast, because the end in the longitudinal direction of the first recess portion 15 is not sensitive to damper performance as compared with the end in the shorthand direction, it is possible to ensure the necessary flexible region 12 while ensuring the adhesion between the substrate 11 and the flexible film 13 due to the increased width of the protrusion of the adhesive 14.

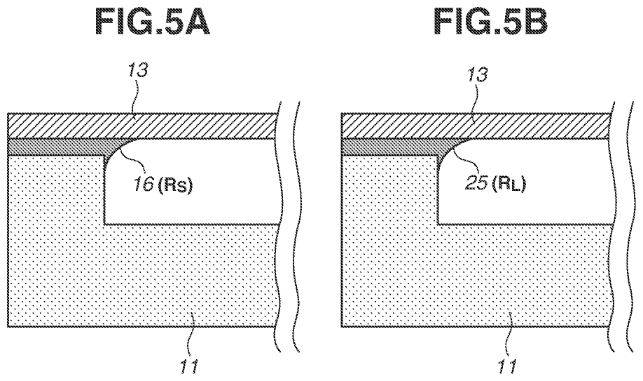

FIGS. 5A and 5B are cross-sectional views each schematically illustrating the adhesive 14 protruding to the inside at one end portion of the first recess portion 15, regarding the flexible film 13 bonded to the first recess portion 15 via the adhesive 14. FIG. 5A illustrates the end portion in the shorthand direction. FIG. 5B illustrates the end portion in the longitudinal direction. Each of the protruding portions 16 and 25 of the adhesive 14 is curved so that a substantially circular shape is inscribed across the side wall of the first recess portion 15 and the flexible film 13 in the inner side direction of the first recess portion 15. That is, the protruding adhesive 14 has a curved surface. With respect to a radius of this inscribed circle, when a curvature radius in the shorthand direction of the first recess portion 15 (the adhesive 14 protruding to the long side of the damper film 13) is Rₛ and a curvature radius in the longitudinal direction (the adhesive 14 protruding to the short side of the damper film 13) is R_{L}, R_{L}/Rₛ>1 is preferably satisfied. With the configuration in which a cross section of the protrusion of the adhesive 14 has the above-mentioned shape, at the end in the shorthand direction of the first recess portion 15 of the damper, the necessary flexible region 12 can be ensured by the reduction of the protrusion of the adhesive 14, while the adhesion between the substrate 11 and the flexible film 13 can also be ensured due to the large width of the protruding portion 16 in the extending direction of the first recess portion 15. In contrast, because the end in the longitudinal direction of the first recess portion 15 is not sensitive to damper performance as compared with the end in the shorthand direction, it is possible to ensure the necessary flexible region 12 while ensuring the adhesion between the substrate 11 and the flexible film 13 due to the increased width of the protrusion of the adhesive 14.

As the substrate 11 included in the liquid ejection head 10, for example, a single crystal silicon substrate can be used. As a method of forming the recess portions and openings in the above-mentioned substrate 11, for example, dry etching can be used. In the first recess portion 15, a communicating opening that communicates with a lower surface side of the substrate 11 may be formed. A protective film (not illustrated) may be formed on a surface with which liquid from the liquid ejection head 10 comes into contact. As the flexible film 13, for example, a resin member such as a polyimide member, a polyamide member, a polyamide imide member, and an epoxy member can be used. As a method of forming an opening in the flexible film 13, an opening can be formed by dry etching, or photolithography in a case where the flexible film 13 is made of photosensitive resin.

As the adhesive 14, for example, epoxy, acrylic, urethane, silicone, benzocyclobutene, polyimide, polyamide, polyamide imide, cyanoacrylate, phenol, melamine, styrene, cyclized rubber, a mixture thereof, or the like can be used.

As described above, according to the present exemplary embodiment, the liquid ejection head can ensure the necessary flexible region while also providing the adhesion between the substrate (flow path substrate) and the flexible film.

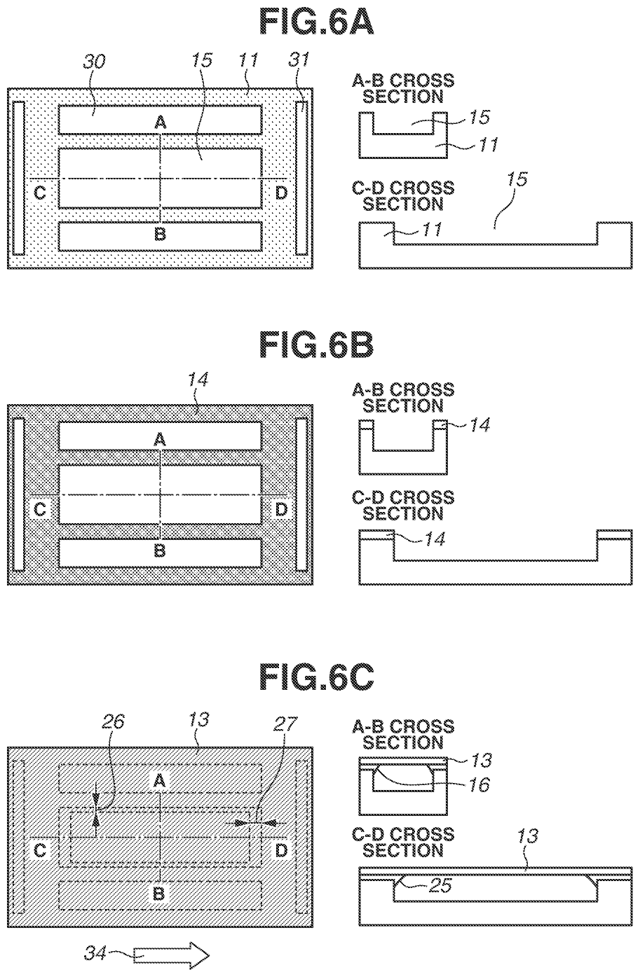

A method of manufacturing a liquid ejection head substrate according to a second exemplary embodiment is now described with reference to FIGS. 6A to 6C. As illustrated in FIG. 6A, prepared is the substrate 11 on which the first recess portion 15, the second recess portion 30, and the third recess portion 31 are formed. A thickness of the substrate 11 is, for example, 400 to 725 μm. In the first recess portion 15, the communicating opening (not illustrated) that communicates with the lower surface side of the substrate 11 may be formed.

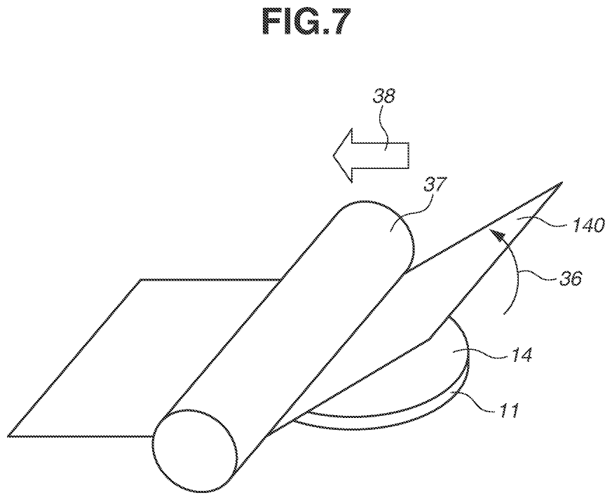

As illustrated in FIG. 6B, the adhesive 14 is applied to a top surface of the substrate 11 including a beam portion between the first recess portion 15 and the second recess portion 30 and a beam portion between the first recess portion 15 and the third recess portion 31 in the substrate 11. The adhesive 14 is formed, for example, by an adhesive transfer method illustrated in FIG. 7. With the adhesive transfer method, the adhesive 14 formed on a film 140 is brought in contact with the surface of the substrate 11 in which the first recess portion 15 is formed with a roller 37, and thereafter the film 140 is peeled from the surface of the substrate 11 in a direction of an arrow 36. This is a method of transferring the adhesive 14 so that part of the adhesive 14 remains on the surface of the substrate 11. With this method, the adhesive 14 is not transferred onto the first recess portion 15, and is transferred only to the surface of the substrate 11 including beam portions around the first recess portion 15. With this method, it is possible to form the adhesive 14 on the end portions of the first recess portion 15. Thus, in a process of laminating the flexible film 13 illustrated in FIG. 6C, the adhesive 14 is squashed, whereby the protruding portions 16 and 25 of the adhesive 14 can be formed inside the first recess portion 15. When comparison is made between an amount of the adhesive 14 transferred onto the beam portion between the first recess portion 15 and the second recess portion 30 and an amount of the adhesive 14 transferred onto the beam portion between the first recess portion 15 and the third recess portion 31, the amount of the adhesive 14 transferred onto the beam portion having a larger width between the first recess portion 15 and the third recess portion 31 is relatively larger because an average film thickness is approximately identical. The adhesive 14 described in the first exemplary embodiment can be used.

As illustrated in FIG. 6C, the flexible film 13 is laminated onto (bonded to) the substrate 11 via the adhesive 14. A scanning direction 34 of a lamination roller (not illustrated) is a direction that is approximately parallel with the longitudinal direction of the first recess portion 15. At this time, the flexible film 13 is laminated onto the substrate 11 while a load is applied to the lamination roller in a state where the adhesive 14 is softened by heating of a substrate stage (not illustrated) that supports the substrate 11 and the lamination roller. Lamination may be performed in vacuum or in atmospheric air. Because the adhesive 14 flows while being pushed out by the lamination roller via the flexible film 13 in the softened state, the flowing adhesive 14 protrudes to the first recess portion 15. At this time, because a direction in which the adhesive 14 is pushed out is the longitudinal direction of the first recess portion 15, which is approximately parallel with the scanning direction 34 of the lamination roller, the width of the protrusion of the adhesive 14 in the longitudinal direction is larger than that in the shorthand direction. Furthermore, in terms of a difference in volume of the adhesive 14 due to the interval from the first recess portion 15 to the second recess portion 30 and the interval from the first recess portion 15 to the third recess portion 31, the width of the protrusion of the adhesive 14 in the longitudinal direction of the first recess portion 15, which is approximately parallel with the scanning direction 34 of the lamination roller, can be made larger. Hence, in the shorthand direction of the first recess portion 15 of the damper, the necessary flexible region 12 can be ensured by reduction of the width 26 of the protruding portion 16 of the adhesive 14, while the adhesion between the substrate 11 and the flexible film 13 can also be ensured due to the large width of the protruding portion 16 of the adhesive 14 in the extending direction of the first recess portion 15. In contrast, because the end in the longitudinal direction of the first recess portion 15 is not sensitive to damper performance as compared with the end in the shorthand direction, it is possible to ensure the necessary flexible region 12 while ensuring the adhesion between the substrate 11 and the flexible film 13 due to the increased width 27 of the protruding portion 25 of the adhesive 14.

In a case where the flexible film 13 has a film shape in which a linear expansion coefficient is different within a plane, lamination may be performed with a planer direction in which the linear expansion coefficient of the flexible film 13 is high being approximately parallel with the extending direction of the first recess portion 15. For example, in a case where the linear expansion coefficient of the flexible film 13 in a machine direction (MD) is higher than that in a transverse direction (TD), lamination may be performed with the MD direction being approximately parallel with the scanning direction 34 of the lamination roller. At the time of lamination on the flexible film 13, the flexible film 13 is slightly extended in the scanning direction of the lamination roller by the lamination roller that is heated and to which a load is applied. The flexible film 13 contracts according to the linear expansion coefficient in a process in which a temperature of the flexible film 13 returns to a room temperature after the lamination. For this reason, the adhesive 14 protrudes to the inside of the first recess portion 15 according to contraction of the flexible film 13. Hence, the width of the protrusion of the adhesive 14 in the longitudinal direction of the first recess portion 15, which is the scanning direction of the lamination roller, can be made larger than that in the shorthand direction. Hence, in the shorthand direction of the first recess portion 15 of the damper, the necessary flexible region 12 can be ensured by reduction of the width of the protruding portion 16 of the adhesive 14, while the adhesion between the substrate 11 and the flexible film 13 can also be ensured due to the large width of the protruding portion 16 of the adhesive 14 in the extending direction of the first recess portion 15. In contrast, because the end in the longitudinal direction of the first recess portion 15 is not sensitive to damper performance as compared with the end in the shorthand direction, it is possible to ensure the necessary flexible region 12 while ensuring the adhesion between the substrate 11 and the flexible film 13 due to the increased width 27 of the protruding portion 25 of the adhesive 14.

According to the above-mentioned manufacturing method, it is possible to make the width of the protrusion of the adhesive in the shorthand direction smaller than that in the longitudinal direction at the inner end portion of the first recess portion. With this configuration, it is possible to provide the method of manufacturing the liquid ejection head substrate that can ensure the necessary flexible region while ensuring the adhesion between the flow path substrate and the flexible film.

A method of manufacturing the liquid ejection head 10 using the liquid ejection head substrate manufactured by the above-mentioned manufacturing method is performed using a general method.

The liquid ejection head 10 according to the first exemplary embodiment is now described with reference to FIGS. 2A and 2B.

The liquid ejection head 10 includes the plurality of ejection ports 22, the plurality of pressure chambers 23 each communicating with a corresponding one of the plurality of ejection ports 22, and the plurality of individual flow paths 17 each communicating with a corresponding one of the plurality of pressure chambers 23. As a result of measuring the widths of the protruding portions 16 and 25 of the adhesive 14 at several locations to obtain respective average values, the width at the end portion in the longitudinal direction of the first recess portion 15 was 60 μm, and the width at the end portion in the shorthand direction was 30 μm. Thus, the width of the protrusion in the shorthand direction was smaller.

Accordingly, it is possible to provide the liquid ejection head capable of ensuring the necessary flexible region while ensuring the adhesion between the flow path substrate and the flexible film.

The method of manufacturing the liquid ejection head substrate according to the second exemplary embodiment is now described with reference to FIGS. 6A to 6C.

The substrate 11 for the liquid ejection head was manufactured in a method similar to the method described in the second exemplary embodiment. The substrate 11 including the first recess portion 15 was prepared. The substrate 11 was made of single crystal silicon. A thickness of the substrate 11 was 625 μm. A width in the shorthand direction of the first recess portion 15 was 800 μm. The process of transferring the adhesive 14 onto the surface of the first recess portion 15 was performed using the transfer method described in the second exemplary embodiment. In the process of laminating the flexible film 13, lamination was performed by matching the direction that was approximately parallel with the longitudinal direction of the first recess portion 15 with the scanning direction of the lamination roller. The widths of the protruding portions 16 and 25 of the adhesive 14 protruding to the inside of the first recess portion 15 of the substrate 11 for the liquid ejection head were measured at a plurality of locations to obtain respective average values. The width of the protruding portion 25 of the adhesive 14 at the end portion in the longitudinal direction of the first recess portion 15 was 80 μm, and the width of the protruding portion 16 of the adhesive 14 at the end portion in the shorthand direction was 40 μm. Thus, the protrusion at the end portion in the shorthand direction could be formed so as to have a smaller width.

According to the present disclosure, since it is possible to make the width of the protruding portion of the adhesive in the shorthand direction smaller than that in the longitudinal direction at the inner end portion of the first recess portion, it is possible to provide the method of manufacturing the liquid ejection head substrate that can ensure the necessary flexible region while ensuring the adhesion between the flow path substrate and the flexible film.

According to the present disclosure, it is possible to provide the liquid ejection head that ensures the flexible region necessary for the flexible film to function as the damper while also providing adhesion between the substrate and the flexible film, and the method of manufacturing the liquid ejection head.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-121554, filed Jul. 26, 2023, which is hereby incorporated by reference herein in its entirety.

What is claimed is:

1. A liquid ejection head comprising:
an ejection port configured to eject liquid;
a pressure generating element configured to generate pressure to eject liquid from the ejection port;
a pressure chamber on which pressure of the pressure generating element acts;
a damper film configured to suppress vibrations of liquid in the pressure chamber; and
a first substrate including a recess portion to make the damper film flexible,
wherein the damper film is bonded to the first substrate with an adhesive so as to cover the recess portion,
wherein the adhesive protrudes from a bonding surface between the damper film and the first substrate to an inside of the recess portion, and
wherein, a portion of the adhesive protruding on a long side of the damper film has a width smaller than a width of a portion of the adhesive protruding to a short side of the damper film.

2. The liquid ejection head according to claim 1, further comprising:
a second substrate including a plurality of the ejection ports and a plurality of the pressure chambers; and
a third substrate including the pressure generating element,
wherein an individual flow path formed in each of the plurality of pressure chambers and a common flow path communicating with a plurality of the individual flow paths are formed in the third substrate,
wherein the first substrate is disposed on one side of the third substrate on which the common flow path is formed so that the recess portion faces the common flow path, and
wherein the damper film faces the common flow path.

3. The liquid ejection head according to claim 2, wherein the damper film is configured to suppress vibrations of liquid in the common flow path to suppress vibrations of liquid in the pressure chamber.

4. The liquid ejection head according to claim 1, wherein the recess portion is formed along an array direction of the ejection port.

5. The liquid ejection head according to claim 2, wherein the recess portion is formed over a whole region of the common flow path.

6. The liquid ejection head according to claim 1, wherein, when a width of a short side of the recess portion is Mₛ and a width of the adhesive protruding to a long side of the damper film is Hₛ, 2H/Mₛ is 0.2 or less.

7. The liquid ejection head according to claim 1, wherein, when a width of a short side of the recess portion is Mₛ and a width of the adhesive protruding a long side of the damper film is Hₛ, 2Hₛ/Mₛ is 0.1 or less.

8. The liquid ejection head according to claim 1, wherein, when a width of a short side of the recess portion is Mₛ and a width of a flexible region in a shorthand direction of the damper film is Dₛ, Dₛ/Mₛ is 0.8 or more.

9. The liquid ejection head according to claim 1, wherein, when a width of a short side of the recess portion is Mₛ and a width of a flexible region in a shorthand direction of the damper film is Dₛ, Dₛ/Mₛ is 0.9 or more.

10. The liquid ejection head according to claim 1,
wherein the adhesive protruding to the inside of the recess portion has a curved surface, and
wherein, when a curvature radius of the adhesive protruding to a long side of the damper film is Rₛ and a curvature radius of the adhesive protruding to a short side of the damper film is R_{L}, R_{L}/Rₛ>1 is satisfied.

11. A method of manufacturing a liquid ejection head substrate, the liquid ejection head substrate comprising:
a damper film configured to suppress vibrations of liquid; and
a first substrate including a recess portion to make the damper film flexible,
the method comprising:
applying an adhesive to the first substrate; and
bonding the damper film to the first substrate so as to cover the recess portion,
wherein the bonding includes rolling a lamination roller to bond the damper film to the first substrate, and
wherein the lamination roller is rolled along a longitudinal direction of the damper film.

12. The method of manufacturing the liquid ejection head substrate according to claim 11, wherein, in a case where a linear expansion coefficient of the damper film is different within a plane of the damper film, the lamination roller is rolled in a state where a direction in which the linear expansion coefficient of the damper film is high is along a longitudinal direction of the recess portion.
